(19) United States
(12) Patent Application Publication
(10) Pub. No.: US 2026/0171643 A1
(43) Pub. Date: Jun. 18, 2026

(54) SUPERCONDUCTING MAGNET-LESS CIRCULATOR FOR MONOLITHICALLY INTEGRATED QUANTUM MEMORY DEVICES

(71) Applicant: Dell Products L.P., Round Rock, TX (US)

(72) Inventors: Tejinder Singh, Manotick (CA); Navjot Kaur Khaira, Manotick (CA)

(21) Appl. No.: 18/967,611

(22) Filed: Dec. 3, 2024

(51) Int. Cl. H01P 1/38; H01F 6/06

(52) U.S. Cl. CPC H01P 1/38; H01F 6/06

(57) ABSTRACT

The technology described herein is directed towards a cryogenic magnet-less circulator device, in which the circulator device is based on the spatiotemporal modulation of angular momentum for microwave photons, controlled using a modulated control signal. The circulator device is configured for integration with a quantum computer, e.g., to facilitate qubit measurements. The circulator topology and design are based on tank circuits, e.g., arranged in a star topology with different sets of radio frequency superconducting quantum interference devices (rf-SQUIDS) per tank circuit, that resonate out-of-phase based on the modulated control signal. The circulator can be fabricated on a layered superconducting chip using standard semiconductor processes, allowing one or more circulators to be integrated on the same superconducting chip as the qubits. A classical computer can be used to output the modulated control signal, and adapt the modulated control signal as needed under varying conditions.

### RELATED APPLICATIONS

The subject patent application is related to U.S. patent application Ser. No. 18/919,198, filed Oct. 17, 2024, and entitled “MAGNET-LESS CIRCULATOR FOR HYBRID-CLASSICAL QUBIT READ-OUT SYSTEMS WITH BUILT-IN PHASE MODULATION” (docket no. 139932.01/DELLP1308US), and U.S. patent application Ser. No. ______, filed ______, and entitled “MULTI-RESONATOR RANDOM ACCESS QUANTUM MEMORY WITH INTEGRATED MAGNET-LESS CIRCULATOR” (docket no. 140735.01/DELLP1358US), the respective entireties of which patent applications are hereby incorporated by reference herein.

### BACKGROUND

A circulator device (or simply “circulator”) is a nonreciprocal three-port device that controls the direction of signal flow. Unlike reciprocal devices where signals can flow in both directions equally, a circulator allows signals to travel in only one predetermined direction among its three ports.

Cryogenic circulators are used for the accurate readout of quantum bits (qubits). Cryogenic circulators operate by isolating successive components in the qubit readout line and preventing back-reflected signals from interfering with sensitive components such as the qubit or readout amplifiers. Traditional circulators, which rely on magnetic biasing of ferrite materials, are challenging to integrate with other superconducting components, in part due to their bulky nature and the need for large, incompatible magnetic bias fields.

### BRIEF DESCRIPTION OF THE DRAWINGS

The technology described herein is illustrated by way of example and not limited to the accompanying figures in which like reference numerals indicate similar elements and in which:

FIG. 1 is an example simulation model for a magnet-less circulator including three inductor-capacitor (LC) tank circuits with a microwave modulation signal provided to each (left portion), corresponding to a circulator with input/output ports and a control signal or signals (right portion), in accordance with various example embodiments and implementations of the subject disclosure.

FIG. 2 is a representation of a layout of an example magnet-less circulator chip, in accordance with various example embodiments and implementations of the subject disclosure.

FIG. 3 is a top view representation of an example layout of a magnet-less circulator chip, in accordance with various example embodiments and implementations of the subject disclosure.

FIG. 4 is a side view representation of an example of a magnet-less circulator stack, in accordance with various example embodiments and implementations of the subject disclosure.

FIG. 5 is a three-dimensional (3D) view representation of an example of a magnet-less circulator stack, in accordance with various example embodiments and implementations of the subject disclosure.

FIGS. 6 and 7 comprise an example simulation model for a magnet-less circulator, in accordance with various example embodiments and implementations of the subject disclosure.

FIG. 8 is a representation of three 120° out-of-phase microwave modulation control signals corresponding to a magnet-less circulator, in accordance with various example embodiments and implementations of the subject disclosure.

FIG. 9 is a conceptual representation of a quantum computer including a dilution refrigerator with qubits and two coupled magnet-less circulators (one configured for clockwise signal routing and one configured for counterclockwise signal routing), in accordance with various example embodiments and implementations of the subject disclosure.

FIG. 10A is an example simulated surface plot of S-parameters versus the normalized modulation frequency and normalized modulation amplitude with respect to isolation of the magnet-less circulator, in accordance with various example embodiments and implementations of the subject disclosure.

FIG. 10B is an example simulated surface plot of S-parameters versus the normalized modulation frequency and normalized modulation amplitude with respect to insertion loss of the magnet-less circulator, in accordance with various example embodiments and implementations of the subject disclosure.

FIG. 11 is an example simulated surface plot of S-parameters versus the normalized modulation frequency and normalized modulation amplitude with respect to return loss of the magnet-less circulator, in accordance with various example embodiments and implementations of the subject disclosure.

FIG. 12A is an example simulated three-dimensional plot of S-parameters versus the normalized modulation frequency and normalized modulation amplitude with respect to isolation of the magnet-less circulator, in accordance with various example embodiments and implementations of the subject disclosure.

FIG. 12B is an example simulated three-dimensional plot of S-parameters versus the normalized modulation frequency and normalized modulation amplitude with respect to insertion loss of the magnet-less circulator, in accordance with various example embodiments and implementations of the subject disclosure.

FIG. 13A is an example simulated three-dimensional plot of S-parameters versus the normalized modulation frequency and normalized modulation amplitude with respect to return loss of the magnet-less circulator, in accordance with various example embodiments and implementations of the subject disclosure.

FIG. 13B is an example graphical representation of simulated S-parameters showing non-reciprocal operation of a magnet-less circulator, in accordance with various example embodiments and implementations of the subject disclosure.

FIGS. 14 and 15 comprise a flow diagram showing example operations related to routing a quantum bit (qubit) signal flow from a first circulator port to a second circulator port while impeding the qubit signal flow in the opposite direction, in accordance with various example embodiments and implementations of the subject disclosure.

### DETAILED DESCRIPTION

The technology described herein is generally directed to a magnet-less cryogenic circulator topology and design, built on a layered superconducting chip. The magnet-less circulator is based on using spatiotemporal modulation of angular momentum for microwave photons to facilitate coupling of an input signal obtained at a first circulator port of a circulator device (or simply “circulator”) to a second circulator port, while impeding the flow of the signal to a third circulator port. As will be understood, the magnet-less cryogenic described herein achieves nonreciprocity while eliminating the need for circulators to rely on magnetic bias fields, resulting in reduced physical circulator size, and facilitating seamless integration with superconducting qubits. Indeed, the circulators described herein are relatively compact, low-loss, and magnet-free for integration with qubits, including on a single superconducting chip.

In one implementation, the control signal(s) for operation of the circulator can be provided by a classical computer, e.g., through a peripheral component interconnect express (PCIe)-based interface. There can be a single control line that provide the circulator modulation, or alternatively individual control lines, which allows precise control and synchronization of the modulation signals, while accommodating a larger number of qubits in the same dilution refrigerator, if, for example, a single control line is used, due to the reduced number of control wires needed per circulator. The integration facilitates seamless, real-time control of the circulator parameters, enhancing the flexibility and efficiency of quantum readout operations. By leveraging PCIe-based control, quantum systems can achieve seamless integration and compatibility with existing classical computing infrastructure, facilitating hybrid quantum-classical systems. This integration simplifies the process and reduces costs, as it aligns with widely-used classical hardware.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

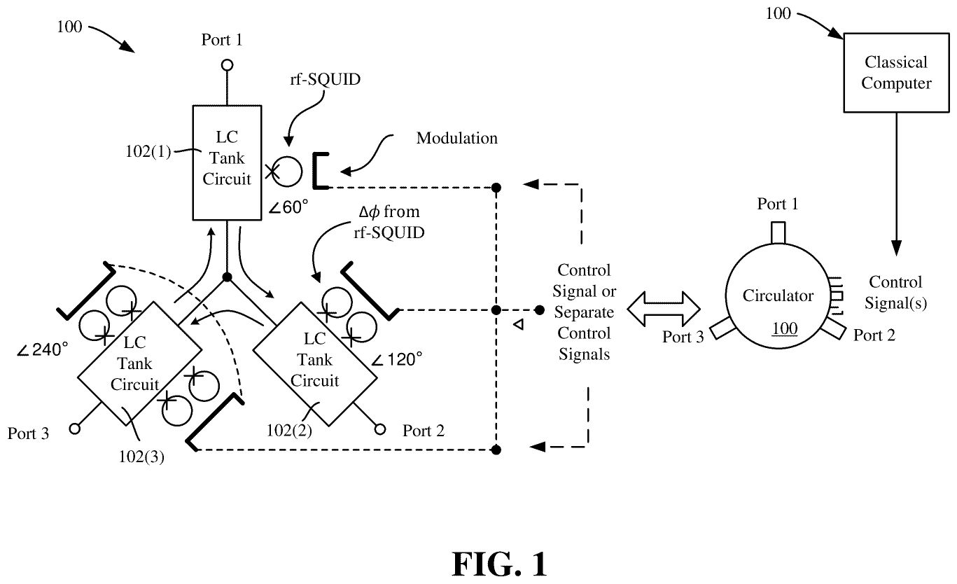

FIG. 1 shows one example magnet-less circulator design 100 that includes three inductor-capacitor (LC) tank circuits 102(1)-102(3) interconnected in a star topology. Each of the LC tank circuits 102(1)-102(3) is basically a resonator that is modulated to create an effective angular momentum bias, facilitating nonreciprocal transmission. The modulation frequencies and amplitudes can be optimized to achieve desired isolation and insertion loss characteristics, making such a circulator compact, magnet-free, and suitable for integration with superconducting qubits.

For electromagnetic waves, generating angular momentum to achieve nonreciprocity can be accomplished through spatiotemporal modulation using a travelling wave. In one implementation, the circulator device 100 thus includes the three identical LC tank circuits 102(1)-102(3), strongly and symmetrically interconnected in a star topology as shown in FIG. 1, each with a fixed-value capacitor and inductor.

The tank circuit inductors are strongly coupled to rf-SQUIDs (radio frequency superconducting quantum interference devices), making them flux tunable. Each rf-SQUID has one Josephson junction shunted by an inductive superconductive loop; in FIG. 1, each rf-SQUID is represented as a generally circulator loop with a crossed “x” portion representing a Josephson junction. A Josephson junction is a fundamental component in superconducting quantum circuits, made from two superconductors separated by a thin insulating barrier. When a current flows through the junction, the current can tunnel through the insulator without any voltage drop, a phenomenon known as the Josephson effect. A rf-SQUID combines the physical phenomenon of flux quantization and Josephson tunneling. Each rf-SQUID is further coupled to a control line providing a phase change of 60° to each SQUID. The control line is provided with a modulation signal of an appropriate amplitude and frequency. The control line can be shared or there can be an individual control line per rf-SQUID.

The circuit represented in FIG. 1 does not allow transmission to any port without modulation; however, when angular momentum is imparted, the degenerate modes of the loop split, facilitating nonreciprocal transmission. To achieve the circulator operation, the resonant frequencies of three LC tank circuits 102(1)-102(3) are modulated by the control signal with identical amplitude and a relative phase difference of 120° between the consecutive ones as shown in FIG. 1, effectively imparting electronic angular momentum to the system. Three oscillatory microwave tones are used to modulate the inductance and, therefore, the frequency of three resonant circuits in a cyclic manner. By selecting the appropriate modulation amplitude and frequency, the two modes interfere destructively at one port (port 3) and constructively at the other port (port 2), thus fulfilling the operation of a circulator. Note that this is based on having one rf-SQUID used with the first LC tank circuit 102(1), two rf-SQUIDs used with the second LC tank circuit 102(2) to provide 120° phase difference between the first and second tank circuits, and four rf-SQUIDs used with the third LC tank circuit 102(3) to provide another 120° phase difference between the second and third tank circuits (and hence a 240° phase difference between the first and third tank circuits).

In one implementation, with this topology the control signal or signals for operation of the circulator 100 can be provided from a classical computer 108, e.g., with a PCIe-based interface. Note that in varying conditions, the modulation frequency and amplitude can be tuned by the classical computer 108 to provide robust operation according to any new conditions. Further, any divergence from the 120 degree or 240 degree phase difference can be maintained, e.g., if the first LC tank circuit 102(1) is at 14 degrees, the second LC tank circuit 102(2) can be set to 134 degrees, and the third LC tank circuit 102(3) can be set to 254 degrees. Leveraging interfaces such as PCIe allows quantum systems to seamlessly integrate and remain compatible with existing classical computing infrastructure, facilitating the creation of hybrid quantum-classical systems. This alignment with widely-used classical hardware simplifies the integration process and reduces costs.

To summarize thus far, magnet-less circulators are described herein, in contrast to the large, low-bandwidth magnet-based circulators used in existing quantum measurement setups, which use bulky magnetic materials and external magnetic fields. Note that traditional magnet-based circulators can be highly impractical for integration, as the magnetic fields from traditional circulators can interfere with the qubits themselves, which are highly-sensitive to external magnetic fields; magnetic materials also can behave unpredictably at these extremely low temperatures, affecting performance. The magnet-less circulators described herein are far more compact and integrable, supporting the scaling up of quantum computers.

The magnet-less circulators described herein are based on the spatiotemporal modulation technique, somewhat akin to a compact acoustic circulator used to achieve sound isolation and nonreciprocity via mechanical rotation. Instead of mechanical rotation, electronic spatiotemporal modulation is used for microwave photons in the quantum computing circulators.

Mathematically, the circuit can be represented as three resonators with resonance frequencies of ω₁, ω₂, and ω₃ coupled to each other with a coupling coefficient k. Without modulation, the three LC tanks resonate at the same frequency of:

$${ω}_{1} = {ω}_{2} = {ω}_{3} = {ω}_{0} = 1 / \sqrt{{L}_{0} C} .$$

With temporal modulation

$${ω}_{1} ( t ) = {ω}_{0} + {a}_{m} cos ( {ω}_{m} t )$$

$${ω}_{2} ( t ) = {ω}_{0} + {a}_{m} cos ( {ω}_{m} t + 2 π / 3 )$$

$${ω}_{3} ( t ) = {ω}_{0} + {a}_{m} cos ( {ω}_{m} t + 4 π / 3 ) ,$$

where ω₀ is the static value of the resonant frequency, am is the modulation amplitude and ωₘ is the modulation frequency. The current flowing through the three resonators can be interpreted as a superposition of two counter-rotating modes. Without modulation, these two counter-rotating modes are degenerate; consequently, if a signal is applied from one port, transmission to the other ports is equal and the network is reciprocal. When modulation is applied, the modulation synthesizes an effective angular-momentum bias in the clockwise direction because the phases of the modulation signals increase by 120° in that direction, thus lifting the degeneracy of the rotating modes and enabling them to oscillate at different frequencies, achieving a nonreciprocal routing of the signals between the ports.

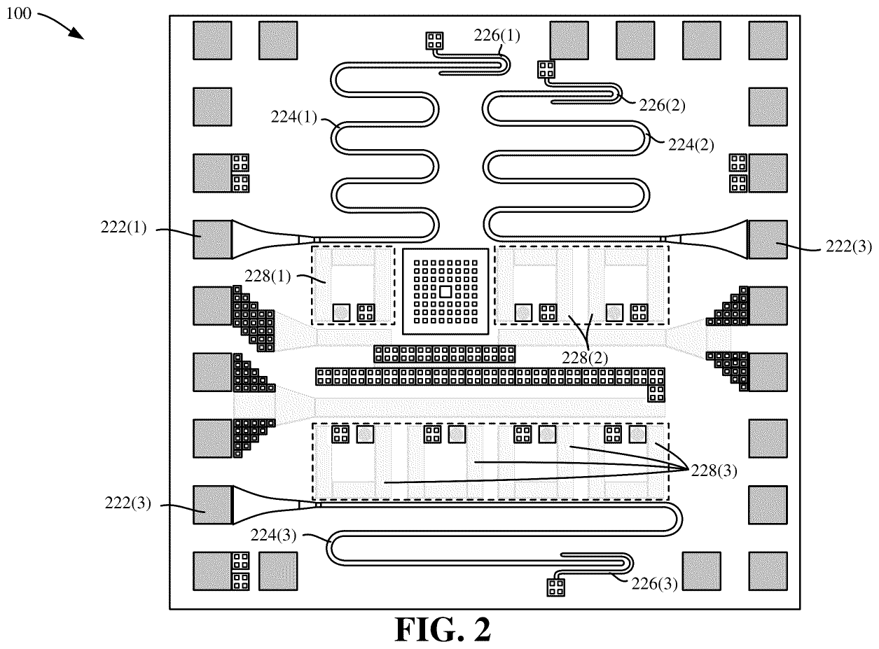

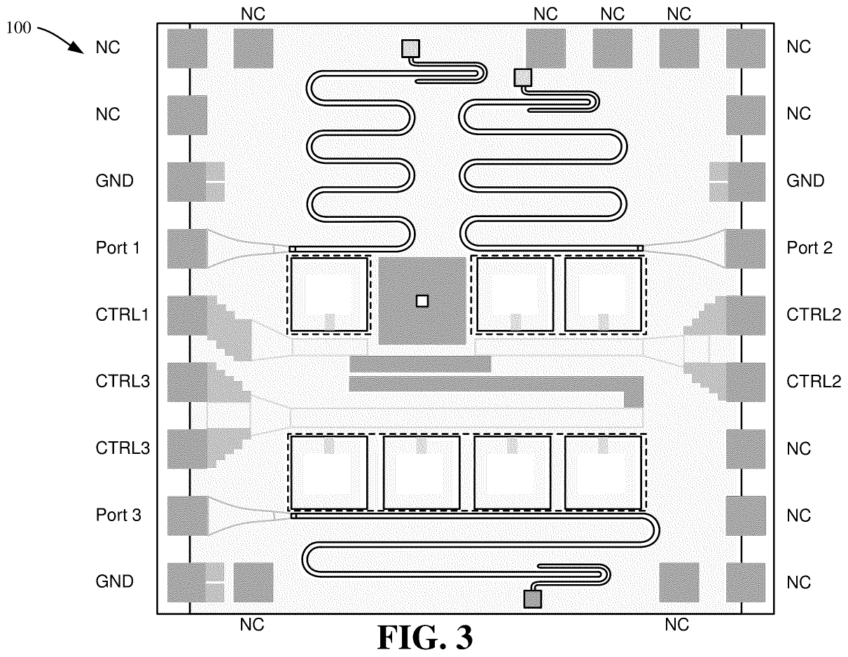

FIGS. 2 and 3 show two-dimensional views of a chip layout of an example magnet-less circulator 100, highlighting various internal layers and connection pads. Non-connected pads are identified as “NC” in FIG. 3. Port 1 222(1) is the first port of the circulator 100 where the signal input is given, port 2 222(2) is the first output port to which the signal from port 1 222(1) travels. Any signal input at port 3 will go through port 3 222(3) without any leakage to port 1 (unless the ports are not mismatched or intentionally shorted).

As can be seen in FIG. 2, the ports 222(1)-222(3) are coupled to inductors 224(1)-224(3), respectively which in this implementation are serpentine (meandering) microstrip lines. The inductors 224(1)-224(3), respectively are coupled in series to capacitors 226(1)-226(3), respectively. To provide the increasing phase shift differences, the rf-SQUID set 228(1) facilitates 1× tuning for the first inductor 224(1), the rf-SQUID set 228(2) facilitates 2× tuning for the second inductor 224(2), and the rf-SQUID set 228(3) facilitates 4× tuning for the third inductor 224(3). In other words, only one rf-SQUID is coupled to the port 1 resonator/inductor 224(1), while to achieve double the phase modulation at port 2 compared to port 1, two rf-SQUIDs are placed along the microstrip superconducting inductor 224(2). Subsequently, four rf-SQUIDs are integrated along port 3's inductor 224(3) to double the phase modulation compared to port 2. This design and method offer spatio-temporal modulation to achieve EM-wave spin without using any magnets near qubits.

The control signals can change the magnetic flux of the rf-SQUID sets 228(1)-228(3), respectively, which are magnetically coupled to the inductors 224(1)-224(3), respectively. The interconnects are shown as small squares; note that multiple interconnects can be present, such as for a single control signal, so as to not increase inductance while allowing more current flow. The control lines for the subsequent ports 222(1)-222(3) ports are respectively identified in FIG. 3 as CTRL1, CTRL2, and CTRL3.

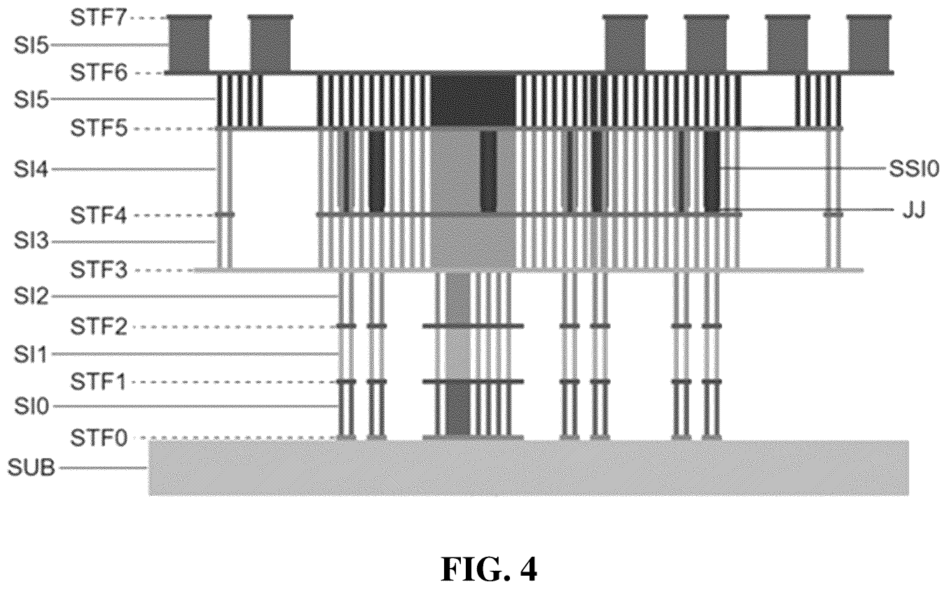

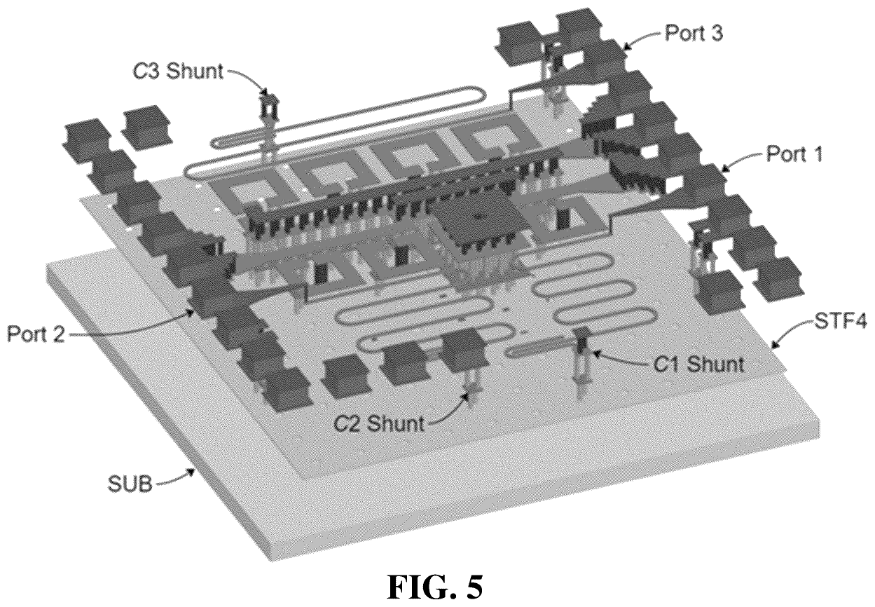

The inductors 224(1)-224(3) are placed at certain distance to avoid any cross coupling, while the capacitors 226(1)-226(3) are connected in series with the inductors 224(1)-224(3), respectively, and shunted to ground while keeping them apart from any parasitic interference. Primary circuits are designed using a top superconducting thin-film (STF) layer of the layer maps shown in FIG. 4. FIG. 4 thus shows a fabrication stack cross-section, which includes multiple superconducting thin films (STF0-STF6) above a substrate (SUB) connected using superconducting interconnects (SI0-SI5). Also shown in FIG. 4 is a short SI (SSI0), and a Josephson Junction (JJ). The 3D stack of the circulator device is shown in FIG. 5, highlighting the internals, shunt points, and other details.

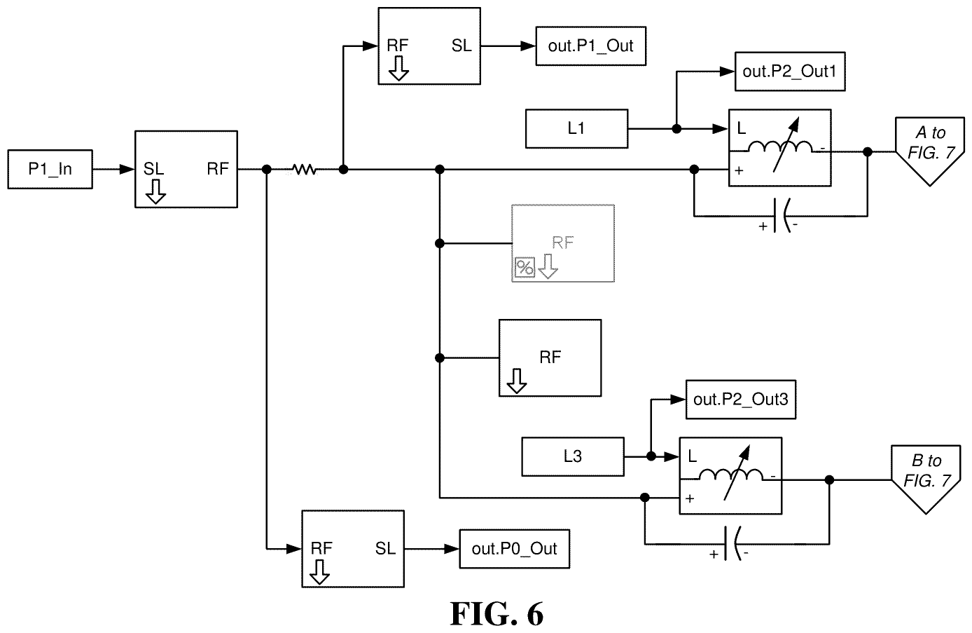

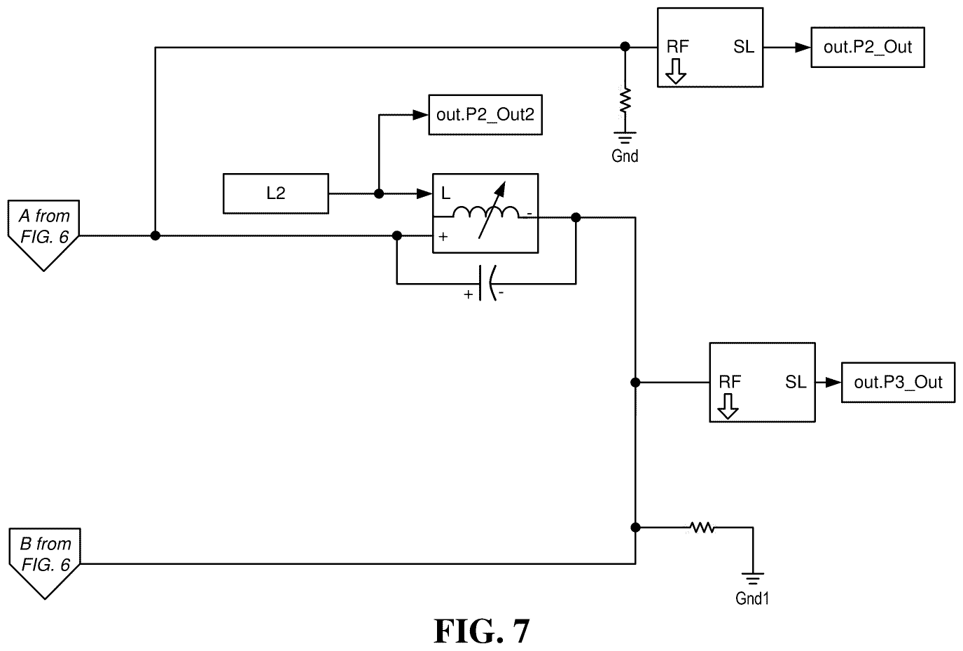

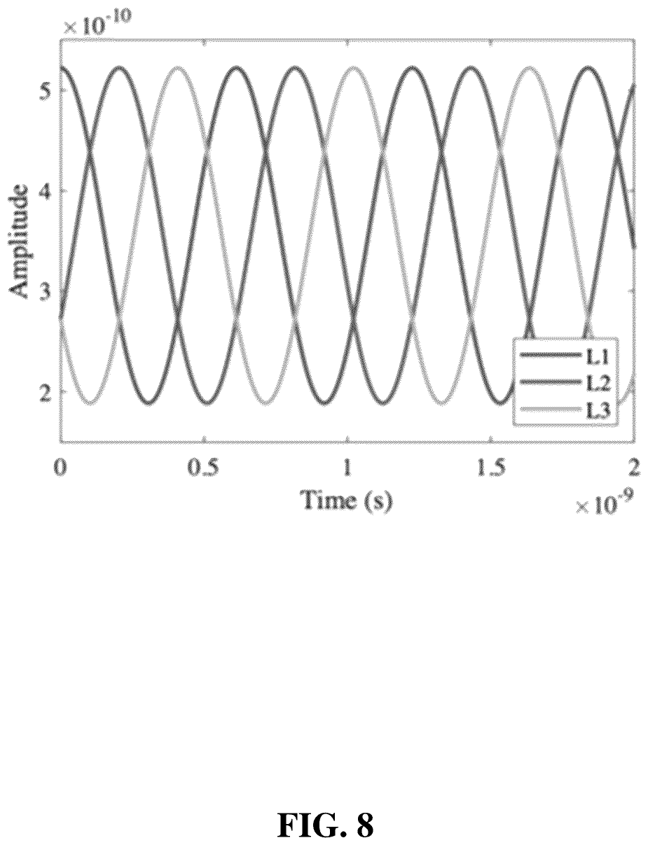

A simulation model for a circulator with the three LC tank circuits and a microwave modulation signal is provided was used to simulate the circuit in MATLAB. More particularly, to validate the technology described herein, the circuit depicted in FIGS. 6 and 7 shows a simulated model for the circulator, (e.g., based on MATLAB and SIMULINK), for the three LC tank circuits connected in a Star topology. FIG. 8 highlights the 120° out of phase microwave modulation control signals. The modulation signal is applied in a clockwise manner, with a 120° phase increment between the successive ports.

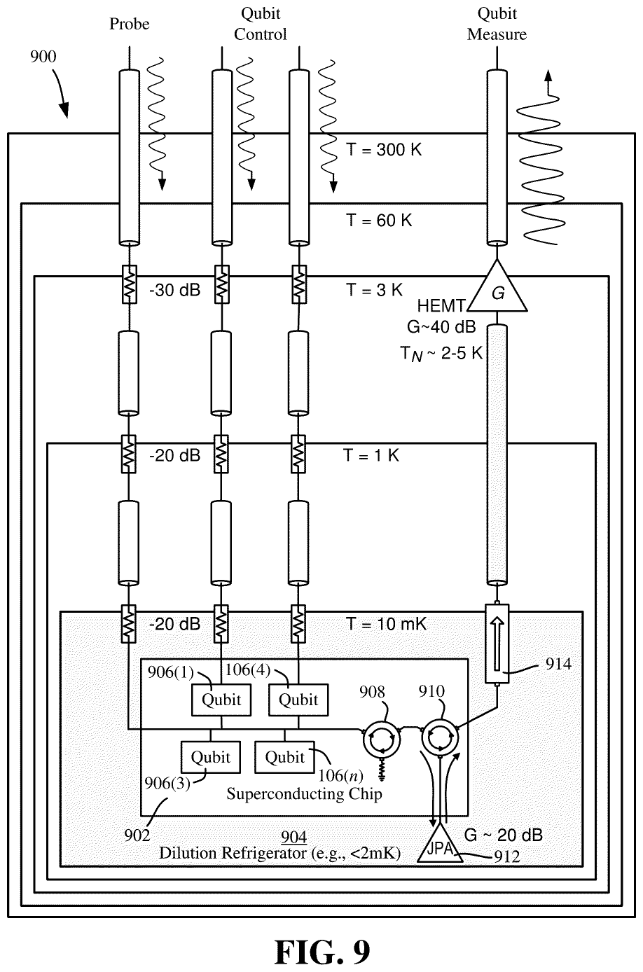

FIG. 9 is a block diagram representation of an example quantum processor measurement and control setup/system 900 including a typical measurement and control setup for a superconducting quantum computing chip 902 near the base plate of a dilution refrigerator 904 on the order of 90 milli-Kelvin (mK). Some number of qubits 906(1)-906(n) (four are depicted, but any practical number may be present) are fabricated on the superconducting quantum computing chip 902. Significantly, unlike magnet-based circulators, described herein are magnet-less circulators 908 and 910 that can be fabricated on the superconducting quantum computing chip 902.

Also shown in FIG. 9 as part of the qubit measuring portion is a Josephson parametric amplifier (JPA) 912, an isolator 914 and a high electron mobility transistor (HEMT) G. In general, a probe signal that is a set of strongly attenuated microwave tones (<−120 dBm) is by injected via coaxial cables (depicted as unshaded cylinders) and attenuators to the qubits 906(1) 906(n) through the various levels of the quantum processor 900, resulting in a measurement signal being input via a readout line to a first port of the magnet-less circulator 908. As described herein, the magnet-less circulator 908 is configured for clockwise rotation, whereby the signal is routed to a second port (low insertion loss) and not the third port (high isolation, and coupled via resistor to ground), nor returned to the first port (low return loss). The second port is coupled to the input port of a second magnet-less circulator 910 configured for counterclockwise rotation, such that the signal is routed to at least one Josephson parametric amplifier (JPA) 912, with the amplified measurement signal routed back to the output port of the second magnet-less circulator 910 though the isolator 914 to the HEMT G for further gain before measurement by one or more conventional RF devices (not explicitly shown). Note that the shaded cylinder shown in the measurement signal output path represents a superconducting coaxial cable. Based on the measurement results, qubit control signals can be sent to the qubits 906(1)-906(n).

Thus, each magnet-less circulator is a nonreciprocal three-port device that allows signals to travel in only one predetermined direction among its three ports, whereby the qubit readout line uses such circulators 908 or 910 to provide isolation between different components so as to maintain the fidelity of the qubit readout. By isolating different parts of the readout circuit, circulators help in reducing noise that could otherwise affect the qubit's state and/or the accuracy of the readout. Multiple circulators are used in the quantum computing setup, ensuring that signals are correctly channeled to the appropriate destinations as shown in FIG. 9.

To summarize, the state of each of the superconducting qubits is probed, and the readout involves amplifying and delivering the measured result back to room temperature. The weak output signal from a qubit is amplified using one or more superconducting parametric amplifiers, such as Josephson parametric amplifiers (JPA), operating at 10 mK and semiconductor high electron mobility transistor (HEMT) amplifiers operating at 4 K. The RF circulators are used to protect the quantum circuit from reflections and noise; the probing, control, and readout of qubit systems involves a large amount of microwave hardware.

Ideally, the signal applied at port 1 should be routed entirely to port 2 (with minimal insertion loss), with no signal at port 3 (maximum isolation). In order to find the values of frequency and amplitude of the modulation signal that lead to the desired circulation operation, the input signal transmission to the three ports is noted for a sweep of frequency values and amplitude.

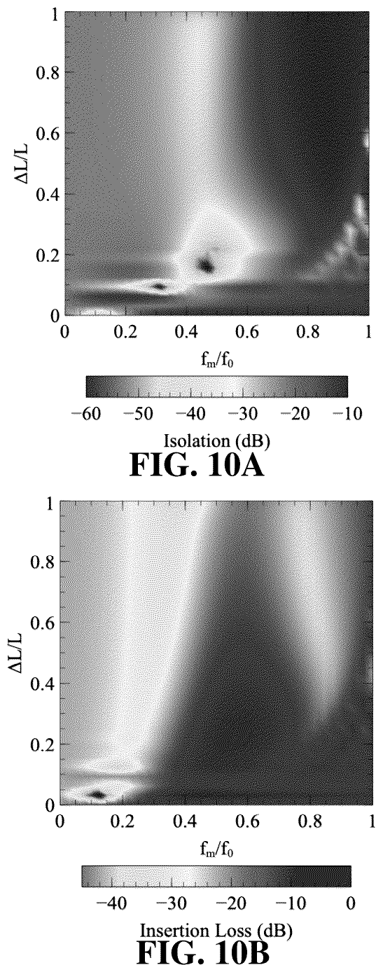

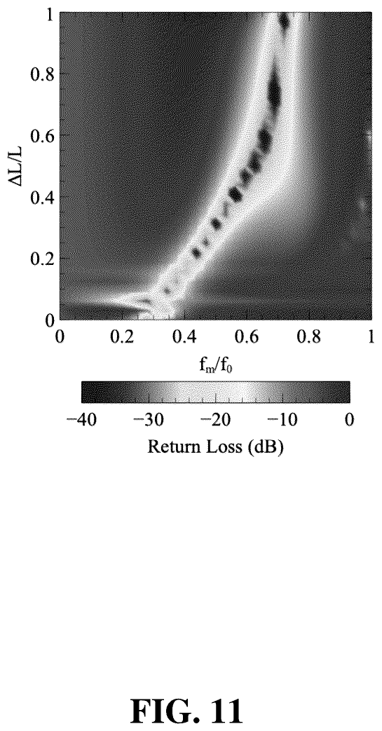

FIGS. 10A and 10B show the S-parameters versus the normalized modulation frequency fₘ/f₀ and normalized modulation amplitude ΔL/L₀ for f₀=10 GHz, C=0.76 pF, L₀=0.37 nH. For a signal applied at port 1, FIG. 10A shows the surface plot of transmitted signal (in dB) to port 3 (isolation), while FIG. 10B shows the signal (in dB) received at port 2 (insertion loss). FIG. 11 shows the reflected signal (in dB) back to port 1 (return loss).

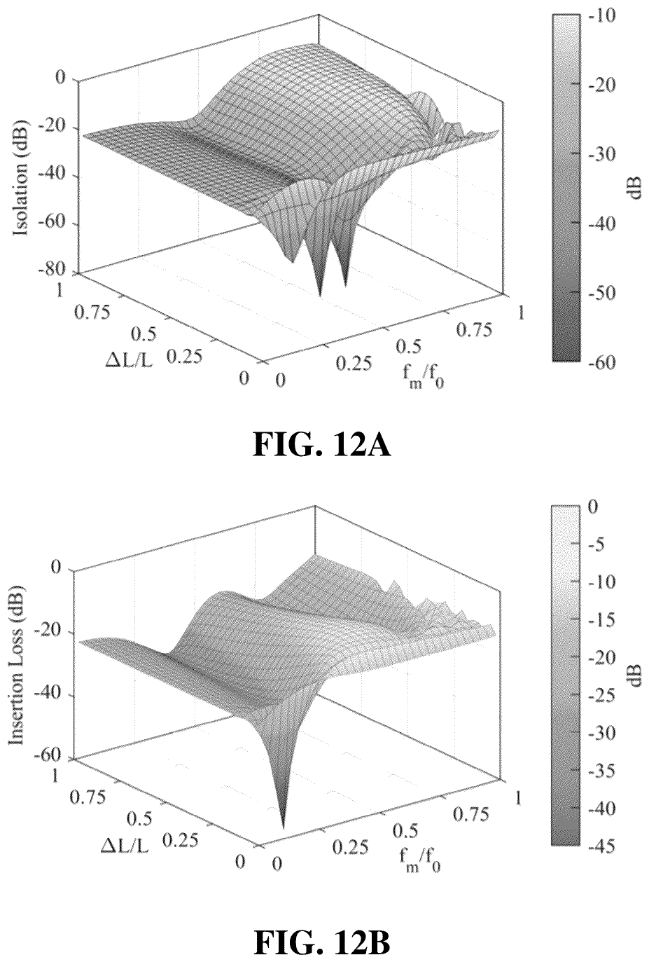

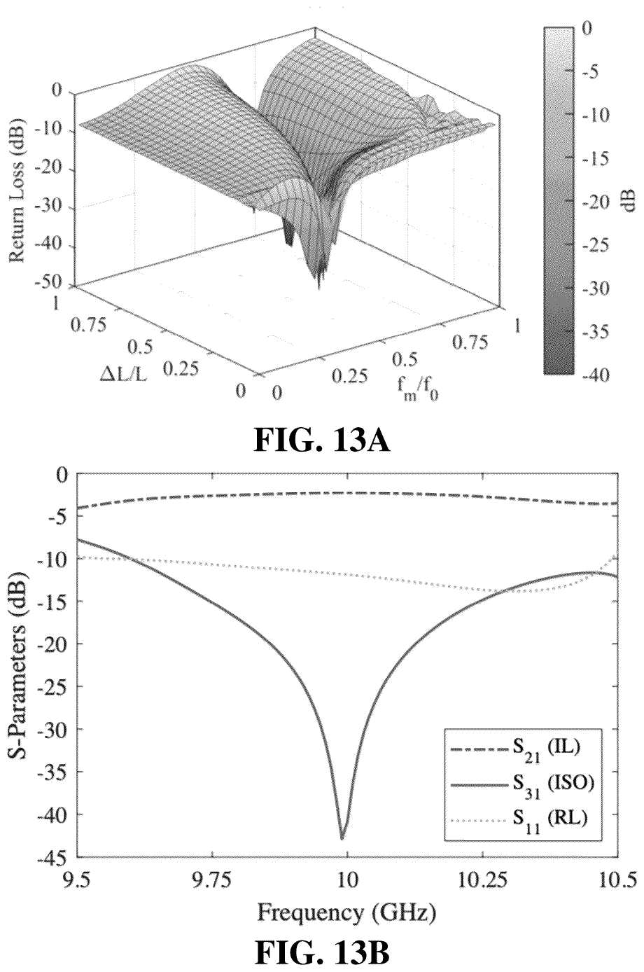

FIGS. 12A, 12B and 13A show the 3D plots of isolation (S₃₁), insertion loss (S₂₁) and return loss (S₁₁). The simulation results in FIGS. 12A, 12B and 13A, along with FIGS. 10A, 10B and 11 help in finding the modulation parameters for which the S-parameters become optimum, ideally, with minimum return loss, minimum insertion loss, and maximum isolation. These quantities do not necessarily become optimum under the same modulation parameters, and therefore it may be necessary to trade off one of them when selecting the best possible modulation parameters. In this case, the selected modulation frequency is 1.63 GHz and the amplitude is 0.47 times the inductance L₀.

In simulations, a center frequency of circulator at 10 GHz was assumed. At a modulation frequency of 1.63 GHZ, the device exhibits significant isolation, insertion loss, and return loss, of 43 dB, 2 dB, and 12 dB, respectively, at 10 GHz as shown in FIG. 13B.

One or more implementations and embodiments can be embodied in a system, such as described and represented in the example herein. The system can include a superconducting magnet-less circulator device. The superconducting magnet-less circulator device can include a first circulator port coupled to a first tank circuit, and the first tank circuit can include a first inductor and a first capacitor resonating at a first resonant frequency, as controlled by a first modulated microwave frequency control signal coupled to a first radio frequency-superconducting quantum interference device (rf-SQUID) set inductively coupled to the first tank circuit. The superconducting magnet-less circulator device can include a second circulator port coupled to a second tank circuit, and the second tank circuit can include a second inductor and a second capacitor resonating at a second resonant frequency as controlled by a second modulated microwave frequency control signal coupled to a second rf-SQUID set inductively coupled to the second tank circuit. The superconducting magnet-less circulator device can include a third circulator port coupled to a third tank circuit, and the third tank circuit can include a third inductor and a third capacitor resonating at a third resonant frequency as controlled by a third modulated microwave frequency control signal coupled to a third rf-SQUID set inductively coupled to the third tank circuit. For an input signal obtained at the first port, the first resonant frequency and the second resonant frequency interfere constructively to facilitate a flow of the first input signal to the second port, and the first resonant frequency and the third resonant frequency interfere destructively to impede the flow of the first input signal to the third port.

The first inductor can include a first serpentine superconducting microstrip line comprising a first starting portion coupled to the first circulator port and a first ending portion coupled to the first capacitor, wherein the second inductor can include a second serpentine superconducting microstrip line comprising a second starting portion coupled to the second circulator port and a second ending portion coupled to the second capacitor, and wherein the third inductor can include a third serpentine superconducting microstrip line comprising a third starting portion coupled to the third circulator port and a third ending portion coupled to the third capacitor.

A first phase of the first resonant frequency can be one-hundred-and-twenty degrees phase-shifted relative to a second phase of the second resonant frequency, and a third phase of the third resonant frequency can be two-hundred-and-forty degrees phase-shifted relative to the first phase.

The second rf-SQUID set can include two times as many rf-SQUIDs relative to the first rf-SQUID set, and the third rf-SQUID set can include four times as many rf-SQUIDs relative to the first rf-SQUID set.

The first rf-SQUID set can include a first rf-SQUID, the second rf-SQUID set can include a second rf-SQUID and a third rf-SQUID, and the third rf-SQUID set can include a fourth rf-SQUID, a fifth rf-SQUID, a sixth rf-SQUID, and a seventh rf-SQUID.

The first modulated microwave frequency control signal, the second modulated microwave frequency control signal, and the third modulated microwave frequency control signal can be output via a computing device.

The first modulated microwave frequency control signal, the second modulated microwave frequency control signal, and the third modulated microwave frequency control signal can include a shared control signal inductively coupled to the first tank circuit via the first rf-SQUID set, the second tank circuit via the second rf-SQUID set, and the third tank circuit via the third rf-SQUID set.

The superconducting magnet-less circulator device can be fabricated as a superconducting chip.

The superconducting magnet-less circulator device can be fabricated as a layered superconducting chip.

The first modulated microwave frequency control signal can be coupled to a first control signal contact via a first group of interconnects, wherein the second modulated microwave frequency control signal can be coupled to a second control signal contact via a second group of interconnects, and wherein the third modulated microwave frequency control signal can be coupled to a third control signal contact via a third group of interconnects.

The first rf-SQUID set can be separated from the second rf-SQUID set by an electromagnetic shield.

The superconducting magnet-less circulator device can be coupled to a group of quantum memory devices.

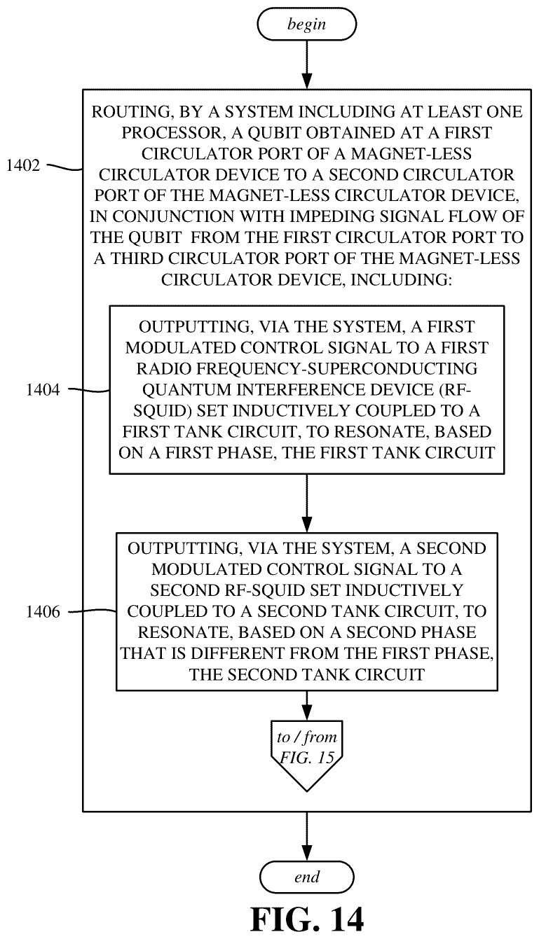

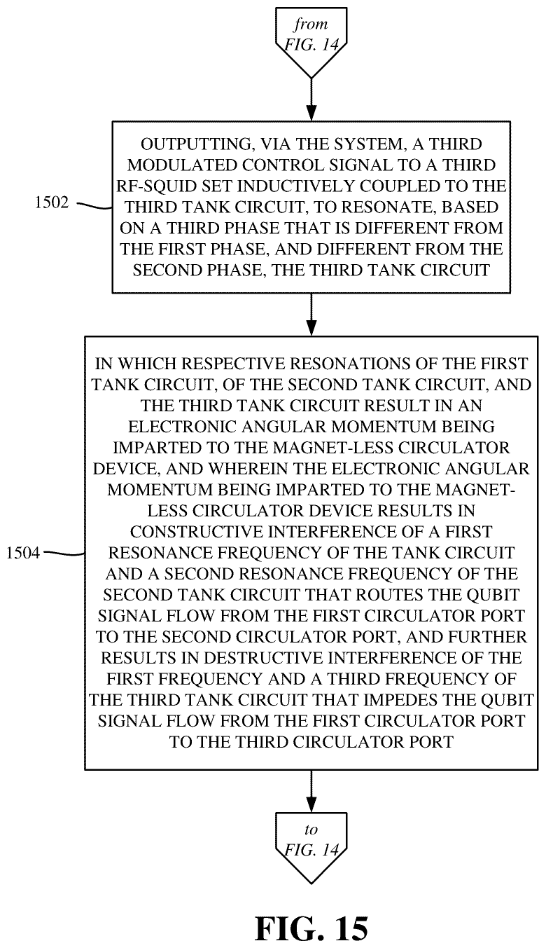

One or more example implementations and embodiments, such as corresponding to example operations of a method, can be represented in FIGS. 14 and 15. Example operation 1402 of FIG. 14 represents routing, by a system comprising at least one processor, a qubit obtained at a first circulator port of a magnet-less circulator device to a second circulator port of the magnet-less circulator device, in conjunction with impeding signal flow of the qubit from the first circulator port to a third circulator port of the magnet-less circulator device, which can include example operations 1404 and 1406 of FIG. 14, and operations 1502 and 1502 of FIG. 15. Example operation 1404 represents outputting, via the system, a first modulated control signal to a first radio frequency-superconducting quantum interference device (rf-SQUID) set inductively coupled to a first tank circuit, to resonate, based on a first phase, the first tank circuit. Example operation 1406 represents outputting, via the system, a second modulated control signal to a second rf-SQUID set inductively coupled to a second tank circuit, to resonate, based on a second phase that is different from the first phase, the second tank circuit. The operations continue at FIG. 15, wherein example operation 1502 represents outputting, via the system, a third modulated control signal to a third rf-SQUID set inductively coupled to the third tank circuit, to resonate, based on a third phase that is different from the first phase, and different from the second phase, the third tank circuit. Example operation 1504 represents that respective resonations of the first tank circuit, of the second tank circuit, and the third tank circuit result in an electronic angular momentum being imparted to the magnet-less circulator device, and wherein the electronic angular momentum being imparted to the magnet-less circulator device results in constructive interference of a first resonance frequency of the tank circuit and a second resonance frequency of the second tank circuit that routes the qubit signal flow from the first circulator port to the second circulator port, and further results in destructive interference of the first frequency and a third frequency of the third tank circuit that impedes the qubit signal flow from the first circulator port to the third circulator port.

Further operations can include writing, via the system, the qubit from the second circulator port to a quantum memory device.

Further operations can include reading, via the system, the qubit from the third circulator port.

One or more implementations and embodiments can be embodied in a system, such as described and represented in the example herein. The system can include a first magnet-less circulator device, and can include a first circulator port, a second circulator port, and a third circulator port; the first circulator port can be coupled to a qubit signal. The system can include a first inductor-capacitor (LC) tank circuit electrically coupled to the first circulator port, and inductively coupled to a first radio frequency-superconducting quantum interference device (rf-SQUID) set, a second LC tank circuit electrically coupled to the second circulator port, and inductively coupled to a second rf-SQUID set, and a third LC tank circuit electrically coupled to the third circulator port, and inductively coupled to a third rf-SQUID set. The system can include a computing device that outputs a first modulated control signal to the first rf-SQUID set corresponding to a first phase shift, a second modulated control signal to the second rf-SQUID set corresponding to a second phase shift, and a third modulated control signal to the third rf-SQUID set corresponding to a third phase shift, to respectively resonate the first LC tank circuit at a first frequency, the second LC tank circuit at a second frequency that is different from the first frequency, and the third LC tank circuit at a third frequency that is different from the first frequency and different from the second frequency. The first frequency, the second frequency and the third frequency impart a first electronic angular momentum to the first magnet-less circulator device, that results in first constructive interference of the first frequency and the second frequency, and first destructive interference of the first frequency and the third frequency, that routes a qubit signal flow from the first circulator port to the second circulator port, and impedes the qubit signal flow from the first circulator port to the third circulator.

The second phase shift can be substantially one-hundred-and-twenty degrees shifted relative to the first phase shift, and the third phase shift is substantially two-hundred-and-forty degrees shifted relative to the first phase shift.

The superconducting magnet-less circulator device can be fabricated as a superconducting chip for coupling to one or more quantum memory cells.

The first rf-SQUID set can include a first rf-SQUID, the second rf-SQUID set can include a second rf-SQUID and a third rf-SQUID, and the third rf-SQUID set can include a fourth rf-SQUID, a fifth rf-SQUID, a sixth rf-SQUID, and a seventh rf-SQUID.

The first LC tank circuit can include a first superconducting microstrip line that can include at least a first portion magnetically coupled to the first rf-SQUID set, the second LC tank circuit can include a second superconducting microstrip line that can include at least a second portion magnetically coupled to the second rf-SQUID set, and the third LC tank circuit can include a third superconducting microstrip line that can include at least a third portion magnetically coupled to the third rf-SQUID set.

As can be seen, the technology described herein facilitates a magnet-less circulator that is significantly advantageous relative waveguide-based bulky magnet-based circulators. The magnet-less circulator described herein can be fabricated using standard semiconductor processes, allowing the design to be integrated more easily on the same chip as the qubits. Such integration facilitates more compact, efficient, and potentially lower-cost quantum computing systems.

The circulator design employs an arrangement of rf-SQUIDs, coupled with three similar resonators, where each subsequent port doubles the number of rf-SQUIDs (1, 2, and 4). This provides a solution for achieving precise phase modulation by ensuring each port has double the phase shift of the previous one, enabling accurate and tunable spatiotemporal modulation of microwave signals. Further, compact and magnet-free signal routing are facilitated, which eliminates the need for bulky magnetic biasing by utilizing rf-SQUIDs in a compact, magnet-free configuration. This reduces the physical size of the circulator and enhances compatibility with superconducting qubits, as it avoids the detrimental effects of magnetic fields, providing a streamlined and efficient integration within cryogenic environments. Enhanced non-reciprocal signal control is facilitated by the use of varying numbers of rf-SQUIDs across the three ports, achieving non-reciprocal signal control. This leverages the inherent properties of rf-SQUIDs to create a controlled and predictable phase shift at each port, allowing for seamless and robust signal routing essential for quantum computing applications.

The compact and magnet-free design, based on electronic modulation, eliminates the need for magnetic biasing of ferrite materials, and thus is unlike conventional ferrite circulators that require bulky magnetic bias fields. Further, the magnet-less circulator offers stable and reliable operation at cryogenic temperatures, unlike magnetic materials used in traditional circulators that can behave unpredictably at cryogenic temperatures, affecting performance. The result is robust operation, even under varying conditions, because the modulation frequency and amplitude are the deciding factors for nonreciprocal transmission. As such, under varying conditions, the modulation frequency and amplitude can be tuned from the classical computer to provide robust operation according to new conditions.

Such magnet-less circulators for quantum systems are highly practical, using spatiotemporal modulation to achieve nonreciprocity for microwave frequencies by leveraging relatively precise electronic control of phase and amplitude, (which is well within the capabilities of modern electronics). Detailed simulations have validated the technology.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a superconducting magnet-less circulator device, comprising:
a first circulator port coupled to a first tank circuit, the first tank circuit comprising a first inductor and a first capacitor resonating at a first resonant frequency, as controlled by a first modulated microwave frequency control signal coupled to a first radio frequency-superconducting quantum interference device (rf-SQUID) set inductively coupled to the first tank circuit,
a second circulator port coupled to a second tank circuit, the second tank circuit comprising a second inductor and a second capacitor resonating at a second resonant frequency as controlled by a second modulated microwave frequency control signal coupled to a second rf-SQUID set inductively coupled to the second tank circuit; and
a third circulator port coupled to a third tank circuit, the third tank circuit comprising a third inductor and a third capacitor resonating at a third resonant frequency as controlled by a third modulated microwave frequency control signal coupled to a third rf-SQUID set inductively coupled to the third tank circuit,
wherein, for an input signal obtained at the first port,
the first resonant frequency and the second resonant frequency interfere constructively to facilitate a flow of the first input signal to the second port, and
the first resonant frequency and the third resonant frequency interfere destructively to impede the flow of the first input signal to the third port.

2. The system of claim 1, wherein the first inductor comprises a first serpentine superconducting microstrip line comprising a first starting portion coupled to the first circulator port and a first ending portion coupled to the first capacitor, wherein the second inductor comprises a second serpentine superconducting microstrip line comprising a second starting portion coupled to the second circulator port and a second ending portion coupled to the second capacitor, and wherein the third inductor comprises a third serpentine superconducting microstrip line comprising a third starting portion coupled to the third circulator port and a third ending portion coupled to the third capacitor.

3. The system of claim 1, wherein a first phase of the first resonant frequency is one-hundred-and-twenty degrees phase-shifted relative to a second phase of the second resonant frequency, and wherein a third phase of the third resonant frequency is two-hundred-and-forty degrees phase-shifted relative to the first phase.

4. The system of claim 1, wherein the second rf-SQUID set comprises two times as many rf-SQUIDs relative to the first rf-SQUID set, and wherein the third rf-SQUID set comprises four times as many rf-SQUIDs relative to the first rf-SQUID set.

5. The system of claim 1, wherein the first rf-SQUID set comprises a first rf-SQUID, wherein the second rf-SQUID set comprises a second rf-SQUID and a third rf-SQUID, and wherein the third rf-SQUID set comprises a fourth rf-SQUID, a fifth rf-SQUID, a sixth rf-SQUID, and a seventh rf-SQUID.

6. The system of claim 1, wherein the first modulated microwave frequency control signal, the second modulated microwave frequency control signal, and the third modulated microwave frequency control signal are output via a computing device.

7. The system of claim 1, wherein the first modulated microwave frequency control signal, the second modulated microwave frequency control signal, and the third modulated microwave frequency control signal comprise a shared control signal inductively coupled to the first tank circuit via the first rf-SQUID set, the second tank circuit via the second rf-SQUID set, and the third tank circuit via the third rf-SQUID set.

8. The system of claim 1, wherein the superconducting magnet-less circulator device is fabricated as a superconducting chip.

9. The system of claim 1, wherein the superconducting magnet-less circulator device is fabricated as a layered superconducting chip.

10. The system of claim 9, wherein the first modulated microwave frequency control signal is coupled to a first control signal contact via a first group of interconnects, wherein the second modulated microwave frequency control signal is coupled to a second control signal contact via a second group of interconnects, and wherein the third modulated microwave frequency control signal is coupled to a third control signal contact via a third group of interconnects.

11. The system of claim 9, wherein the first rf-SQUID set is separated from the second rf-SQUID set by an electromagnetic shield.

12. The system of claim 9, wherein the superconducting magnet-less circulator device is coupled to a group of quantum memory devices.

13. A method, comprising:
routing, by a system comprising at least one processor, a qubit obtained at a first circulator port of a magnet-less circulator device to a second circulator port of the magnet-less circulator device, in conjunction with impeding signal flow of the qubit from the first circulator port to a third circulator port of the magnet-less circulator device, comprising:
outputting, via the system, a first modulated control signal to a first radio frequency-superconducting quantum interference device (rf-SQUID) set inductively coupled to a first tank circuit, to resonate, based on a first phase, the first tank circuit;
outputting, via the system, a second modulated control signal to a second rf-SQUID set inductively coupled to a second tank circuit, to resonate, based on a second phase that is different from the first phase, the second tank circuit; and
outputting, via the system, a third modulated control signal to a third rf-SQUID set inductively coupled to the third tank circuit, to resonate, based on a third phase that is different from the first phase, and different from the second phase, the third tank circuit,
wherein respective resonations of the first tank circuit, of the second tank circuit, and the third tank circuit result in an electronic angular momentum being imparted to the magnet-less circulator device, and wherein the electronic angular momentum being imparted to the magnet-less circulator device results in constructive interference of a first resonance frequency of the tank circuit and a second resonance frequency of the second tank circuit that routes the qubit signal flow from the first circulator port to the second circulator port, and further results in destructive interference of the first frequency and a third frequency of the third tank circuit that impedes the qubit signal flow from the first circulator port to the third circulator port.

14. The method of claim 13, further comprising writing, via the system, the qubit from the second circulator port to a quantum memory device.

15. The method of claim 13, further comprising reading, via the system, the qubit from the third circulator port.

16. A system, comprising:
a first magnet-less circulator device, comprising:
a first circulator port, a second circulator port, and a third circulator port, wherein the first circulator port is coupled to a qubit signal;
a first inductor-capacitor (LC) tank circuit electrically coupled to the first circulator port, and inductively coupled to a first radio frequency-superconducting quantum interference device (rf-SQUID) set,
a second LC tank circuit electrically coupled to the second circulator port, and inductively coupled to a second rf-SQUID set, and
a third LC tank circuit electrically coupled to the third circulator port, and inductively coupled to a third rf-SQUID set;
a computing device that outputs a first modulated control signal to the first rf-SQUID set corresponding to a first phase shift, a second modulated control signal to the second rf-SQUID set corresponding to a second phase shift, and a third modulated control signal to the third rf-SQUID set corresponding to a third phase shift, to respectively resonate:
the first LC tank circuit at a first frequency,
the second LC tank circuit at a second frequency that is different from the first frequency, and
the third LC tank circuit at a third frequency that is different from the first frequency and different from the second frequency,
wherein the first frequency, the second frequency and the third frequency impart a first electronic angular momentum to the first magnet-less circulator device, that results in first constructive interference of the first frequency and the second frequency, and first destructive interference of the first frequency and the third frequency, that routes a qubit signal flow from the first circulator port to the second circulator port, and impedes the qubit signal flow from the first circulator port to the third circulator.

17. The system of claim 16, wherein the second phase shift is substantially one-hundred-and-twenty degrees shifted relative to the first phase shift, and wherein the third phase shift is substantially two-hundred-and-forty degrees shifted relative to the first phase shift.

18. The system of claim 16, wherein the superconducting magnet-less circulator device is fabricated as a superconducting chip for coupling to one or more quantum memory cells.

19. The system of claim 18, wherein the first rf-SQUID set comprises a first rf-SQUID, wherein the second rf-SQUID set comprises a second rf-SQUID and a third rf-SQUID, and wherein the third rf-SQUID set comprises a fourth rf-SQUID, a fifth rf-SQUID, a sixth rf-SQUID, and a seventh rf-SQUID.

20. The system of claim 18, wherein the first LC tank circuit comprises a first superconducting microstrip line comprising at least a first portion magnetically coupled to the first rf-SQUID set, wherein the second LC tank circuit comprises a second superconducting microstrip line comprising at least a second portion magnetically coupled to the second rf-SQUID set, and wherein the third LC tank circuit comprises a third superconducting microstrip line comprising at least a third portion magnetically coupled to the third rf-SQUID set.
